(19) United States
(12) Patent Application Publication
(10) Pub. No.: US 2023/0076536 A1
(43) Pub. Date: Mar. 9, 2023

(54) EXHAUST GAS PURIFICATION CATALYST DEVICE

(71) Applicant: CATALER CORPORATION, Kakegawa-shi, Shizuoka (JP)

(72) Inventors: Tsubasa NANJO, Kakegawa-shi (JP); Yuya KAWANO, Kakegawa-shi (JP); Takuto ARAKAWA, Kakegawa-shi (JP); Yoshinori YAMASHITA, Kakegawa-shi (JP); Shunsuke OHISHI, Kakegawa-shi (JP); Ryosuke TAKASU, Kakegawa-shi (JP)

(73) Assignee: CATALER CORPORATION, Kakegawa-shi, Shizuoka (JP)

(21) Appl. No.: 17/801,349

(22) PCT Filed: Feb. 10, 2021
(86) PCT No.: PCT/JP2021/005050

§ 371 Date: Aug. 22, 2022

(30) Foreign Application Priority Data
Mar. 26, 2020 (JP) 2020-056612

(51) Int. Cl. B01J 23/42; B01J 29/04; B01D 53/94; B01J 23/44; B01J 35/00

(52) U.S. Cl. CPC B01J 23/42; B01J 29/044; B01D 53/9436; B01D 53/9418; B01J 23/44; B01J 35/0006; B01J 2208/00672; B01J 2523/828; B01J 2523/842; B01J 2523/17; B01J 2523/824; B01D 2257/40; B01D 2258/012; B01D 2255/1021; B01D 2255/1023; B01D 2255/9022; B01D 2255/50; B01D 2255/908

(57) ABSTRACT

An exhaust gas purification catalyst device including a substrate and an SCR catalyst layer on the substrate, the substrate containing catalyst precious metal particles directly supported on the substrate, the catalyst precious metal particles containing Pt, and the catalyst precious metal particles having an average particle diameter of 30 to 120 nm inclusive.

### FIELD

The present invention relates to an exhaust gas purification catalytic device.

### BACKGROUND

Selective catalytic reduction (SCR) systems are known as a technique for reducing and purifying NOx in an exhaust gas emitted from a diesel engine before the exhaust gas is released into the atmosphere. The SCR system is a technology which uses a reductant, for example, ammonia, to reduce NO in an exhaust gas to N₂.

In an SCR system, a reductant may be excessively used to improve the reductive purification rate of NOₓ. In this case, a non-reacted reductant not used in the reduction of NOₓ is emitted from an SCR catalyst. When ammonia is used as the reductant, the emission of ammonia from an SCR catalyst is referred to as “ammonia slip”.

It is desirable that the slipped ammonia be oxidatively purified with an ASC (ammonia slip catalyst) and then released into the atmosphere. Accordingly, an ASC is often used in combination with an SCR system, for example, in a state of being laminated with an SCR layer or arranged downstream from an SCR layer.

PTL 1 discloses a bifunctional catalyst for selective ammonia oxidation, comprising platinum (Pt), a second metal, a refractory metal oxide, and a zeolite. PTL 1 describes a general configuration of an ASC.

PTL 2 discloses a bimetallic catalyst for selective ammonia oxidation, comprising a molecular sieve having a silica-to-alumina ratio (SAR) of less than 30, wherein the molecular sieve comprises ion-exchanged copper (Cu) and ion-exchanged platinum (Pt).

PTL 3 discloses a method for measuring an average particle size of noble metal catalyst particles supported on a carrier by a CO pulse method. In the technique of PTL 3, even when the carrier comprises a material exhibiting OSC (oxygen storage capacity), the CO pulse is not consumed by the carrier and substantially all of the CO is adsorbed on the noble metal catalyst particles. PTL 3 describes that the state of noble metal catalyst particles can be accurately evaluated according to the method disclosed therein.

### CITATION LIST

### Patent Literature

[PTL 1] Japanese Unexamined PCT Publication (Kohyo) No. 2010-519039
[PTL 2] Japanese Unexamined PCT Publication (Kohyo) No. 2012-507400
[PTL 3] Japanese Unexamined Patent Publication (Kokai) No. 2005-283129

### SUMMARY

### Technical Problem

N₂O is generated as a side reaction product of the oxidative purification of NH₃ in ASCs. Since N₂O is a greenhouse gas which has an effect on global warming, the emissions thereof should be suppressed.

In an SCR system comprising an ASC, it is difficult to purify generated N₂O by SCR. Therefore, it is desirable that the amount of N₂O generated in the ASC be as small as possible.

In view of the above circumstances, an object of the present invention is to provide an exhaust gas purification catalytic device that has a sufficiently high NH₃ oxidative purification efficiency and generates a small amount of N₂O.

### Solution to Problem

The present invention for achieving the above object is described as follows.

<<Aspect 1>> An exhaust gas purification catalytic device, comprising a substrate and an SCR catalyst layer on the substrate, wherein

the substrate comprises catalytic noble metal particles supported directly on the substrate,

the catalytic noble metal particles comprise Pt, and

the catalytic noble metal particles have an average particle size of 30 nm or more and 120 nm or less.

<<Aspect 2>> The exhaust gas purification catalytic device according to Aspect 1, wherein a noble metal other than Pt in the catalytic noble metal particles has a content ratio of 10% by mass or less with respect to a total mass of the catalytic noble metal particles.
<<Aspect 3>> The exhaust gas purification catalytic device according to Aspect 1 or 2, wherein the catalytic noble metal particles have an average particle size of more than 50 nm and 100 nm or less.
<<Aspect 4>> The exhaust gas purification catalytic device according to any one of Aspects 1 to 3, wherein the SCR catalyst layer comprises a zeolite doped with Cu or Fe.
<<Aspect 5>> The exhaust gas purification catalytic device according to any one of Aspects 1 to 4, wherein the SCR catalyst layer comprises at least one selected from Cu-CHA type zeolite, Cu-BEA type zeolite, Fe-MFI type zeolite, and Fe-BEA type zeolite.
<<Aspect 6>> The exhaust gas purification catalytic device according to any one of Aspects 1 to 5, wherein the catalytic noble metal particles further comprise Pd.
<<Aspect 7>> The exhaust gas purification catalytic device according to any one of Aspects 1 to 6, wherein the exhaust gas purification catalytic device is substantially free of any noble metal other than the catalytic noble metal particles supported directly on the substrate.
<<Aspect 8>> The exhaust gas purification catalytic device according to any one of Aspects 1 to 7, further including an OSC layer comprising ceria.
<<Aspect 9>> The exhaust gas purification catalytic device according to Aspect 8, wherein the ceria is contained in the OSC layer in a ceria-zirconia composite oxide form.
<<Aspect 10>> The exhaust gas purification catalytic device according to Aspect 8 or 9, wherein the OSC layer is included between the substrate and the SCR catalyst layer.

### Advantageous Effects of Invention

According to the present invention, an exhaust gas purification catalytic device that has a sufficiently high NH₃ oxidative purification efficiency and generates a small amount of N₂O is provided.

### BRIEF DESCRIPTION OF DRAWINGS

FIG. 1 is a schematic cross-sectional view showing an example of a configuration of the exhaust gas purification catalytic device of the present invention.

FIG. 2 is a schematic cross-section view showing another example of a configuration of the exhaust gas purification catalytic device of the present invention.

### DESCRIPTION OF EMBODIMENTS

### <<Exhaust Gas Purification Catalytic Device>>

The exhaust gas purification device of the present invention is

an exhaust gas purification catalytic device comprising a substrate and an SCR catalyst layer on the substrate, wherein

the substrate comprises catalytic noble metal particles supported directly on the substrate,

the catalytic noble metal particles comprise Pt, and

the catalytic noble metal particles have an average particle size of 30 nm or more and 120 nm or less.

In the exhaust gas purification device of the present invention, NOx is purified by selective catalytic reduction using ammonia as a reductant via the SCR catalyst layer on the substrate. At this time, the excess ammonia which was excessively supplied and not used for the selective catalytic reduction of NOx is oxidatively purified by the catalytic noble metal particles supported directly on the substrate.

The exhaust gas purification device of the present invention may further include, in addition to the above substrate and SCR catalyst layer, an OSC layer (oxygen storage) comprising ceria.

The OSC layer exhibits an oxygen storage and release capacity and has a function of oxygen storage in a lean atmosphere and oxygen release in a rich atmosphere. Therefore, the NH₃ oxidative purification activity of the catalytic noble metal particles supported directly on the substrate is enhanced, and the oxidative purification ability of NH₃, particularly in a low-temperature region, is further improved. Therefore, the OSC layer is preferably arranged in a location close to the catalytic noble metal particles, and may be present, for example, between the substrate and the SCR catalyst layer.

In conventionally known ASCs, Pt, which functions as an oxidation catalyst for NH₃, is present in a catalytic coating layer on the substrate, in a state of being supported on inorganic oxide carrier particles having a large area. In this case, Pt, as fine particles having a relatively small particle size, is supported on the carrier particles.

However, the present inventors have discovered that there is a limit in the suppression of the amount of N₂O generated regarding ASCs having a configuration which includes a catalytic coating layer comprising Pt particles having a relatively small particle size and supported on a carrier having a large area.

In the present invention, Pt is supported directly on the substrate to form particles having a relatively large particle size, whereby an exhaust gas purification catalytic device that has an excellent oxidative purification efficiency of NH₃ and generates a small amount of N₂O is obtained.

Hereinafter, a typical configuration of the exhaust gas purification catalytic device of the present invention will be described with reference to the drawings.

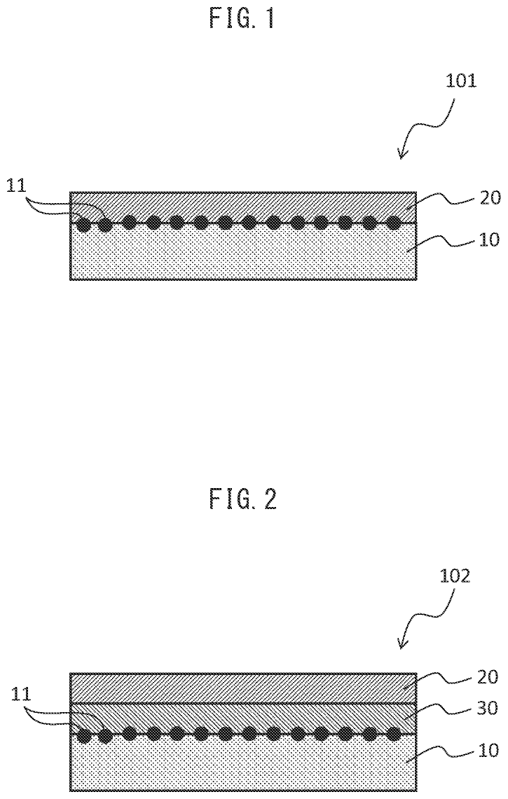

Examples of a configuration of the exhaust gas purification catalytic device of the present invention are shown in FIGS. 1 and 2.

The exhaust gas purification catalytic device (101) in FIG. 1 comprises a substrate (10) and an SCR catalyst layer (20) on the substrate (10). The substrate (10) of this exhaust gas purification catalytic device (101) comprises catalytic noble metal particles (11) supported directly on the substrate (10).

Like the exhaust gas purification catalytic device (101) in FIG. 1, the exhaust gas purification catalytic device (102) in FIG. 2 comprises a substrate (10) and an SCR catalyst layer (20) on the substrate (10), wherein the substrate (10) comprises catalytic noble metal particles (11) supported directly on the substrate (10). However, this exhaust gas purification catalytic device (102) includes an OSC layer (30) between the substrate (10) and the SCR catalyst layer (20).

In the exhaust gas purification catalytic device (101) in FIG. 1 and the exhaust gas purification catalytic device (102) in FIG. 2, the catalytic noble metal particles (11) comprise Pt. The average particle size of these catalytic noble metal particles (11) is 30 nm or more and 120 nm or less.

The OSC layer (30) of the exhaust gas purification catalytic device (102) in FIG. 2 comprises ceria. The ceria in the OSC layer (30) may be contained in the OSC layer (30), for example, in a ceria-zirconia composite oxide form.

Hereinafter, each component of the exhaust gas purification device of the present invention will be described in order.

### <Substrate>

As the substrate of the exhaust gas purification catalytic device of the present invention, a substrate generally used for exhaust gas purification catalytic devices can be used. The substrate may be, for example, a straight-flow monolithic honeycomb substrate composed of a material such as cordierite, SiC, stainless steel, or inorganic oxide particles.

The substrate of the exhaust gas purification catalytic device of the present invention comprises catalytic noble metal particles supported directly on a substrate. The phrase “supported directly on a substrate” means that the catalytic noble metal particles are attached to the substrate not via an inorganic oxide carrier other than the inorganic oxide constituting the substrate.

### (Catalytic Noble Metal Particles)

The catalytic noble metal particles comprise Pt.

The catalytic noble metal particles may comprise a noble metal other than Pt. The noble metal other than Pt contained in the catalytic noble metal particles may be, for example, a platinum group element other than Pt; may be, for example, one or more selected from Ru, Rh, Pd, Os, and Ir; or may be one or more selected from Rh and Pd, particularly Pd.

While it is easy to control the particle size of catalytic noble metal particles comprising Pt and a noble metal other than Pt, there may be a problem that the amount of N₂O generated is large for catalytic noble metal particles having an excessively large content of a noble metal other than Pt. From this viewpoint, the content ratio of the noble metal other than Pt of the catalytic noble metal particles may be 20% by mass or less, 18% by mass or less, 15% by mass or less, 12% by mass or less, 10% by mass or less, 8% by mass or less, 5% by mass or less, 3% by mass or less, or 0% by mass, and may be greater than 0% by mass, 1% by mass or greater, 3% by mass or greater, 5% by mass or greater, 8% by mass or greater, or 10% by mass or greater with respect to the total mass of the catalytic noble metal particles.

The average particle size of the catalytic noble metal particles is 30 nm or more and 120 nm or less. When the average particle size of the catalytic noble metal particles is less than 30 nm, the amount of N₂O generated sometimes increases. On the other hand, when the particle size of the catalytic noble metal particles is more than 120 nm, the oxidative purification ability of NH₃ may be impaired. The average particle size of the catalytic noble metal particles, from the viewpoint of suppressing generation of N₂O, may be, for example, 35 nm or more, 40 nm or more, 45 nm or more, 50 nm or more, more than 50 nm, 55 nm or more, 60 nm or more, or 65 nm or more, and from the viewpoint of improving the oxidative purification ability of NH₃, may be 110 nm or less, 100 nm or less, 90 nm or less, 80 nm or less, 75 nm or less, 70 nm or less, or 65 nm or less. Typically, the particle size of the catalytic noble metal particles may be, for example, more than 50 nm and 100 nm or less.

As used herein, the average particle size of the catalytic noble metal particles is a value measured by a carbon monoxide (CO) pulse method. The particle size of the catalytic noble metal particles are measured in accordance with the method described in PTL 3 (Japanese Unexamined Patent Publication (Kokai) No. 2005-283129).

Specifically, an exhaust gas purification catalytic device is pulverized into small pieces of, for example, 0.5 mm or less as measurement samples, subjected to oxidation and reduction treatments, then treated with carbon dioxide (CO₂), and thereafter used for measurement by a CO pulse method. The oxidation and reduction treatments may be carried out at an appropriately high temperature, for example, 400° C. The CO₂ treatment may be carried out at a relatively low temperature, for example, 50° C. The measurement by a CO pulse method may be carried out at a relatively low temperature, for example, 50° C.

In this method, it is important that the CO₂ treatment of the measurement samples be carried out prior to the measurement by a CO pulse method. When the exhaust gas purification catalytic device comprises an OSC material, adsorption sites of the OSC material are blocked by CO₂ due to the CO₂ treatment. Thus, when a CO pulse method is carried out after a CO₂ treatment, it is considered that substantially all of the CO supplied to the samples is adsorbed on the noble metal catalyst particles without being adsorbed on and consumed by the OSC material.

Therefore, the difference between the amount of CO supplied to the samples by the CO pulse method and the amount of CO contained in the exhaust gas can be estimated as the amount of CO adsorbed on the catalytic noble metal particles.

Assuming that one CO is adsorbed for one catalytic noble metal atom exposed on the surface of a catalytic noble metal particle, the average particle size of the catalytic noble metal particles can be calculated.

The average particle size of the catalytic noble metal particles may be calculated from the amount of CO adsorbed, for example, as follows.

A surface area Am(Metal) (m²/g) per g of catalytic noble metal particles is represented by the following mathematical formula (1), wherein V_{chem} (cm³) is the CO adsorption amount, ρₘ (nm²) is the noble metal cross-sectional area per catalytic noble metal atom, and c (g) is the mass of catalytic noble metal particles per g of measurement sample. SF in the formula (1) is referred to as a “stoichiometry factor”, and is a number indicating the number of CO adsorbed for one catalytic noble metal atom. It is assumed herein that SF=1, as described above.

$$\begin{matrix}[ Math . 1 ] & \\ Am ( Metal ) = \frac{{V}_{Chem} \times S F / 22414 \times 6.02 \times 1 {0}^{23} \times {σ}_{m} \times {10}^{- 18}}{c} & ( 1 )\end{matrix}$$

The surface area Am(Metal) (m²/g) per g of catalytic noble metal particles obtained in the formula (1) can be rewritten as the following mathematical formula (2), using the average radius r (cm) of the catalytic noble metal particles, the number a of catalytic noble metal particles per g of catalytic noble metal particles, and the mass c (g) of the catalytic noble metal particles.

$$\begin{matrix}[ Math . 2 ] & \\ \frac{4 π {r}^{2} \times α}{c} = Am ( Metal ) & ( 2 )\end{matrix}$$

The volume (cm³) per g of catalytic noble metal particles is represented by the following mathematical formula (3), using the average radius r (cm) of the catalytic noble metal particles, the number a of catalytic noble metal particles per g of catalytic noble metal particles, the mass c (g) of the catalytic noble metal particles, and the density ρ (g/cm³) of the catalytic noble metal.

$$\begin{matrix}[ Math . 3 ] & \\ \frac{4 / 3 π {r}^{3} \times α}{c} = 1 / ( ρ \times {10}^{6} ) & ( 3 )\end{matrix}$$

From mathematical formulas (2) and (3), an average radius r (cm) of the catalytic noble metal particles can be calculated by the following mathematical formula (4).

[Math. 4]

r=3/(Am(Metal)×ρ×10⁶) (4)

An average particle size d (nm) of the catalytic noble metal particles can be obtained by the following mathematical formula (5).

[Math. 5]

d=2r×10⁹ (5)

In the exhaust gas purification catalytic device of the present invention, the supported amount of catalytic noble metal particles supported directly on the substrate is arbitrary. However, the mass of the catalytic noble metal particles per L of substrate, from the viewpoint of ensuring a sufficiently high NH₃ oxidative purification ability, may be, for example, 0.01 g/L or more, 0.03 g/L or more, 0.05 g/L or more, 0.08 g/L or more, or 0.10 g/L or more, and from the viewpoint of setting a proper balance between the NH₃ oxidative purification ability and the production cost of the catalytic device, may be, for example, 2.00 g/L or less, 1.50 g/L or less, 1.00 g/L or less, 0.80 g/L or less, 0.50 g/L or less, 0.30 g/L or less, or 0.10 g/L or less.

It is preferable that the exhaust gas purification catalytic device of the present invention be substantially free of any noble metal other than the catalytic noble metal particles supported directly on the substrate. The phrase “the exhaust gas purification catalytic device is substantially free of any noble metal other than the catalytic noble metal particles supported directly on the substrate” means that, of the total mass of noble metals contained in the exhaust gas purification catalytic device, the mass of noble metal other than the catalytic noble metal particles supported directly on the substrate accounts for a ratio of 5% by mass or less, 3% by mass or less, 1% by mass or less, 0.5% by mass or less, 0.3% by mass or less, or 0.1% by mass or less, or the exhaust gas purification catalytic device does not comprise at all any noble metal other than the catalytic noble metal particles supported directly on the substrate.

### <SCR Catalyst Layer>

The exhaust gas purification catalytic device of the present invention includes an SCR catalyst layer on the substrate comprising catalytic noble metal particles supported directly thereon. This SCR catalyst layer comprises a zeolite doped with Cu or Fe. The SCR catalyst layer may further comprise, for example, an optional component such as an inorganic oxide other than a zeolite doped with Cu or Fe or a binder.

(Zeolite Doped with Cu or Fe)

In the SCR catalyst layer, a zeolite doped with Cu or Fe functions as a catalyst for selective reduction of NOx by NH₃.

The crystal structure of the zeolite of the SCR catalyst layer is arbitrary. The crystal structure of a proton zeolite applicable to the present invention, listed with the respective structural code (described in parentheses), may be, for example, A type (LTA), ferrierite (FER), MCM-22 (MWW), ZSM-5 (MFI), mordenite (MOR), L type (LTL), X or Y type (FAU), beta type (BEA), chabazite (CHA), CDO type, or GON type.

Herein, “Cu-” or “Fe-” is added in front of the structural code of the parent zeolite to reference a zeolite doped with Cu or Fe. For example, a chabazite-type parent zeolite doped with Cu is written as “Cu-CHA type zeolite”.

The SCR catalyst layer of the present invention may comprise at least one selected from Cu-CHA type zeolite, Cu-BEA type zeolite, Fe-MFI type zeolite, and Fe-BEA type zeolite.

The doping amount of Cu or Fe with respect to the zeolite, from the viewpoint of ensuring sufficiently high NOx reductive purification activity, may be, for example, 0.5% by mass or greater, 1.0% by mass or greater, 1.5% by mass or greater, 2.0% by mass or greater, 2.5% by mass or greater, or 3.0% by mass or greater independently for each of Cu and Fe, based on the total mass of the zeolite doped with Cu or Fe.

The upper limit of the doping amount of Cu or Fe with respect to the zeolite is not limited from the viewpoint of enhancing NOx reductive purification activity. However, the NOx reductive purification activity does not increase indefinitely if the doping amount is excessively increased. Therefore, from the viewpoint of maintaining proper production cost of the exhaust gas purification catalytic device, the doping amount of Cu or Fe with respect to the zeolite may be, for example, 20% by mass or less, 15% by mass or less, 12% by mass or less, 10% by mass or less, 8% by mass or less, or 6% by mass or less independently for each of Cu and Fe, based on the total mass of the zeolite doped with Cu or Fe.

The amount of zeolite doped with Cu or Fe as the mass of the zeolite per L of substrate, from the viewpoint of ensuring sufficiently high NOx-selective reductive purification ability, may be, for example, 30 g/L or more, 40 g/L or more, 50 g/L or more, 60 g/L or more, 70 g/L or more, or 80 g/L or more, and from the viewpoint of reducing pressure loss of the catalytic device, may be, for example, 200 g/L or less, 150 g/L or less, 120 g/L or less, 110 g/L or less, 100 g/L or less, or 90 g/L or less.

(Inorganic Oxide Other than Zeolite Doped with Cu or Fe)

The SCR catalyst layer may further comprise an inorganic composite oxide other than the zeolite doped with Cu or Fe. The inorganic oxide particles contained in the SCR catalyst layer may be, for example, particles of an oxide having one or more elements selected from aluminum, silicon, titanium, zirconium, and rare earth elements. Examples of the inorganic oxide particles specifically include alumina particles, ceria particles, and ceria-zirconia composite oxide particles.

### (Binder)

The SCR catalyst layer may further comprise a binder. Examples of the binder include alumina sol, zirconia sol, silica sol, and titania sol.

### <OSC Layer>

The exhaust gas purification catalytic device of the present invention may further include an OSC layer comprising ceria.

### (Ceria)

The OSC layer comprises ceria.

The amount of ceria in the OSC layer as the amount of ceria per L of substrate, from the viewpoint of ensuring sufficiently high OSC ability, may be, for example, 1 g/L or more, 3 g/L or more, 5 g/L or more, or 7 g/L or more. From the viewpoint of reducing pressure loss of the catalytic device, the amount of ceria per L of substrate may be, for example, 50 g/L or less, 40 g/L or less, 30 g/L or less, 20 g/L or less, 15 g/L or less, or 10 g/L or less.

The ceria in the OSC layer may be in a pure ceria form, may be contained in the OSC layer in a ceria-zirconia composite oxide form, or may be a mixture thereof. The ceria content in a ceria-zirconia composite oxide contained in the OSC layer may be, for example, 5% by mass or greater, 10% by mass or greater, 20% by mass or greater, 30% by mass or greater, 40% by mass or greater, 50% by mass or greater, 60% by mass or greater, 70% by mass or greater, 80% by mass or greater, or 90% by mass or greater.

As described above, the OSC layer exhibits oxygen storage and release capacity and has a function of improving the NH₃ oxidative purification activity of the catalytic noble metal particles supported directly on the substrate. Therefore, the OSC layer is preferably arranged in a location close to the catalytic noble metal particles, and may be present, for example, between the substrate and the SCR catalyst layer.

### (Optional Component)

The OSC layer may comprise optional components in addition to ceria and a ceria-zirconia composite oxide. An optional component in the OSC layer may be, for example, an inorganic oxide other than ceria and the ceria-zirconia composite oxide or a binder.

The inorganic oxide particles other than ceria and a ceria-zirconia composite oxide contained in the OSC layer may be, for example, particles of an oxide having one or more elements selected from aluminum, silicon, titanium, zirconium, and rare earth elements (excluding cerium). Examples of the inorganic oxide particles specifically include alumina particles and zirconia particles.

Examples of the binder contained in the OSC layer include alumina sol, zirconia sol, silica sol, and titania sol.

### <<Method for Producing Exhaust Gas Purification Catalytic Device>>

The exhaust gas purification catalytic device of the present invention may be produced by any method as long as the catalytic device has the above configuration.

However, the exhaust gas purification catalytic device of the present invention may be produced by a method for producing the exhaust gas purification catalytic device of the present invention, comprising, for example, the following:

supporting catalytic noble metal particles directly on a substrate (catalytic noble metal particles supporting step), and

forming an SCR catalyst layer on the substrate where the catalytic noble metal particles are supported directly thereon (SCR layer formation step).

The method for producing the exhaust gas purification catalytic device of the present invention may further comprise, for example, after the catalytic noble metal particles supporting step and before the SCR catalyst layer formation step, forming an OSC layer (OSC layer formation step).

### (Catalytic Noble Metal Particles Supporting Step)

In the present step, catalytic noble metal particles are supported directly on the substrate.

The substrate may be selected appropriately as the substrate of the desired exhaust gas purification catalytic device. The substrate may be, for example, a straight-flow monolithic honeycomb substrate made of cordierite.

This substrate is coated with a coating liquid containing a catalytic noble metal precursor and baked, whereby catalytic noble metal particles are supported directly on the substrate. The coating layer may be dried, as needed, after coating and before baking.

The catalytic noble metal precursor in the coating liquid may be, for example, a nitrate, a sulfate, a halide, or a complex compound of a desired catalytic noble metal. The complex compound may be, for example, a complex compound comprising a tetraamine complex ion.

The solvent of the coating liquid may be water, an aqueous organic solvent, or a mixture thereof, and is typically water.

The coating of the coating liquid and the drying and baking after the coating may each be carried out according to any publicly known method.

### (SCR Catalyst Layer Formation Step)

In the present step, an SCR catalyst layer is formed on the substrate where catalytic noble metal particles are supported directly thereon.

The present step may be carried out by coating the substrate where catalytic noble metal particles are supported directly thereon with a slurry containing, for example, a zeolite doped with Cu or Fe and an additionally optional component, as needed, followed by baking. The coating layer may be dried, as needed, after coating and before baking.

The dispersion medium of the slurry may be water, an aqueous organic solvent, or a mixture thereof, and is typically water.

The coating of the slurry and the drying and baking after the coating may each be carried out according to any publicly known method.

### (OSC Layer Formation Step)

The present step is a step of forming an OSC layer. This OSC layer formation step may be carried out, for example, after the catalytic noble metal particles supporting step and before the SCR catalyst layer formation step.

Except that the included components are appropriately changed according to the desired OSC layer, the present step may be carried out in the same manner as the SCR catalyst layer formation step.

### EXAMPLES

### <<Preparation of Slurry for Forming Catalytic Coating Layer>>

### (1) Preparation of Pt-Containing Solution

### (1-1) Pt-Containing Solution A1

400 g of pure water and an organic polysaccharide were added to and mixed in a tetraammineplatinum(II) dichloride aqueous solution (0.2 g in terms of Pt metal) by stirring for 3 h to obtain a Pt-containing solution A1.

### (1-2) Pt—Pd-Containing Solution A2

A tetraamminepaladium(II) dichloride aqueous solution (0.02 g in terms of Pd metal) was further added to and dissolved in the Pt-containing solution A1 to obtain a Pt—Pd-containing solution A2.

### (1-3) Pt—Pd-Containing Solution A3

A tetraamminepaladium(II) dichloride aqueous solution (0.01 g in terms of Pd metal) was further added to and dissolved in the Pt-containing solution A 1 to obtain a Pt—Pd-containing solution A3.

### (2) Preparation of Zeolite-Containing Slurry

### (2-1) Zeolite-Containing Slurry B1

85 g of Cu-CHA type zeolite (Cu doping amount of 5% by mass, SAR8) and 15 g of a silica binder sol were dispersed in 200 g of pure water to obtain a zeolite-containing slurry B1.

### (2-2) Zeolite-Containing Slurry B2

Except that 85 g of Cu-BEA type zeolite (Cu doping amount of 5.9% by mass, SAR25) was used in place of the Cu-CHA type zeolite, the same operation as in the preparation of the zeolite-containing slurry B1 was carried out to obtain a zeolite-containing slurry B2.

### (2-3) Zeolite-Containing Slurry B3

Except that 85 g of Fe-MFI type zeolite (Fe doping amount of 2.0% by mass, SAR30) was used in place of the Cu-CHA type zeolite, the same operation as in the preparation of the zeolite-containing slurry B1 was carried out to obtain a zeolite-containing slurry B3.

### (2-4) Zeolite-Containing Slurry B4

Except that 85 g of Fe-BEA type zeolite (Fe doping amount of 5.0% by mass, SAR25) was used in place of the Cu-CHA type zeolite, the same operation as in the preparation of the zeolite-containing slurry B1 was carried out to obtain a zeolite-containing slurry B4.

### (3) CZ-Containing Slurry

A ceria-zirconia composite oxide (ceria content of 56.5% by mass) (CZ) was dispersed in 15 g of water to obtain a CZ-containing slurry.

(4) Pt/Al₂O₃-Containing Slurry

A tetraammineplatinum(II) dichloride aqueous solution (0.1 g in terms of Pt metal) was dissolved in 45 g of pure water to form an aqueous solution. 15 g of alumina was added to this aqueous solution and stirred for 1 h. Subsequently, the mixture was heated to 120° C. for 5 h, and after the water was evaporated, baked at 500° C. for 1 h to obtain a Pt/Al₂O₃ powder. The obtained Pt/Al₂O₃ powder was allowed to disperse in pure water, whereby a Pt/Al₂O₃-containing slurry was prepared.

### Example 1

### (1) Production of Exhaust Gas Purification Catalytic Device

A straight-flow honeycomb substrate made of cordierite (capacity of about 1 L) was coated with the Pt-containing solution A1 over the entire length of the honeycomb substrate and baked at 500° C. for 1 h to have catalytic noble metal particles consisting of Pt supported directly on the honeycomb substrate.

Subsequently, a honeycomb substrate where catalytic noble metal particles are supported directly thereon was coated with the zeolite-containing slurry B1 over the entire length of the honeycomb substrate and baked at 500° C. for 1 h to form an SCR catalyst layer thereon, whereby an exhaust gas purification catalytic device of Example 1 was produced.

### (2) Evaluation of Exhaust Gas Purification Catalytic Device

### (2-1) Measurement of Average Particle Size of Catalytic Noble Metal Particles

The average particle size of the catalytic noble metal particles (Pt particles or Pt—Pd particles) was measured by a carbon monoxide (CO) pulse adsorption method.

Measurement samples obtained by pulverizing the exhaust gas purification catalytic device obtained above into small pieces of 0.5 mm or less were pretreated under the following conditions, and then gas chemical adsorption measurement was carried out by the CO pulse adsorption method to examine the amount of CO adsorbed. The average particle size of Pt was calculated from the calculated adsorption surface area of Pt, assuming that one CO was adsorbed on one Pt molecule, and the supported amount of Pt in the exhaust gas purification catalytic device.

The sample pretreatment conditions were as follows.

Step 1: Flow a He gas containing 10% by volume of oxygen (O₂) while elevating the temperature from room temperature to 400° C. at a temperature elevation rate of 40° C./min.

Step 2: After reaching 400° C., maintain the same temperature, and flow a He gas containing 10% by volume of oxygen (O₂) for 15 min.

Step 3: Maintain at 400° C. and flow helium (He) for 15 min.

Step 4: Maintain at 400° C. and flow a He gas containing 10% by volume of hydrogen (H₂) for 15 min.

Step 5: Maintain at 400° C. and flow He for 15 min.

Step 6: Flow He while lowering the temperature from 400° C. to 50° C. at a temperature drop rate of 35° C./min.

Step 7: Maintain at 50° C. and flow a He gas containing 10% of carbon dioxide (CO₂) for 10 min.

Step 8: Maintain at 50° C. and flow He for 10 min.

The probe gas in the CO pulse adsorption method was a He gas containing 1% by volume of CO. The amount of CO adsorbed was calculated from thermal conductivity measurement with a TCD.

### (2-2) Evaluation of Exhaust Gas Purification Ability

The obtained exhaust gas purification catalytic device was subjected to a hydrothermal endurance treatment by heating at 630° C. for 50 h while flowing air having a water concentration of 10% by volume.

A model gas containing NH₃ and NOₓ of known concentrations was introduced and flowed in the exhaust gas purification catalytic device after the hydrothermal endurance treatment to measure the concentrations of NH₃ and NOₓ in the exhaust gas. An NH₃ oxidation rate and N₂O selectivity calculated by the following mathematical formulas were each determined.

NH₃ oxidation rate (%)={(NH₃ concentration in introduced gas−NH₃ concentration in exhaust gas)/NH₃ concentration in introduced gas}×100

N₂O selectivity (%)={N₂O concentration in exhaust gas×2/(NH₃ concentration in introduced gas−NH₃ in exhaust gas)}×100

The model gas introduction conditions were set as follows.
Model gas introduction temperature: 250° C.
Model gas composition: NO: 0 ppm, NH₃: 500 ppm, O₂: 10%, H₂O: 5%, and balance of N₂
Space velocity during model gas introduction: 60,000 hr⁻¹

NH₃ oxidation rate and N₂O selectivity for the exhaust gas purification catalytic device of Example 1, measured under the above conditions, are shown in Table 1.

### Example 2

Except that the Pt—Pd-containing solution A2 was used in place of the Pt-containing solution A1 to have Pt—Pd alloy particles (9.1% by mass of Pd) as catalytic noble metal particles supported directly on a honeycomb substrate, the same operation as in Example 1 was used to produce an exhaust gas purification catalytic device of Example 2, and the produced catalytic device was evaluated. The evaluation results are shown in Table 1.

### Example 3

An exhaust gas purification catalytic device produced in the same manner as in Example 2 was further baked at 630° C. for 50 h, whereby an exhaust gas purification catalytic device of Example 3 was produced.

The obtained exhaust gas purification catalytic device was evaluated in the same manner as in Example 1. The evaluation results are shown in Table 1.

### Example 4

Except that the Pt—Pd-containing solution A3 was used in place of the Pt-containing solution A1 to have Pt—Pd alloy particles (16.7% by mass of Pd) as catalytic noble metal particles supported directly on a honeycomb substrate, the same operation as in Example 1 was used to produce an exhaust gas purification catalytic device of Example 4, and the produced catalytic device was evaluated. The evaluation results are shown in Table 1.

### Examples 5 to 7

Except that the respective zeolite-containing slurries B2 (Example 5), B3 (Example 6), and B4 (Example 7) are used in place of the zeolite-containing slurry B1, the same operation as in Example 1 was used to produce each exhaust gas purification catalytic device of Examples 5 to 7, and the produced catalytic devices were evaluated. The evaluation results are shown in Table 1.

### Example 8

### (1) Production of Exhaust Gas Purification Catalytic Device

The same type of cordierite honeycomb substrate (capacity of about 1 L) as the one used in Example 1 was coated with the Pt-containing solution 1 over the entire length of the honeycomb substrate and baked at 500° C. for 1 h to have catalytic noble metal particles consisting of Pt supported directly on the honeycomb substrate. Subsequently, the CZ-containing slurry was coated on the honeycomb substrate having the catalytic noble metal particles supported directly thereon over the entire length of the honeycomb substrate and dried to form an OSC layer. Further, the OSC layer was coated thereon with the zeolite-containing slurry B1 over the entire length of the honeycomb substrate and baked at 500° C. for 1 h to form an SCR catalyst layer, whereby an exhaust gas purification catalytic device of Example 8 was produced.

### (2) Evaluation of Exhaust Gas Purification Catalytic Device

The obtained exhaust gas purification catalytic device was evaluated in the same manner as in Example 1. The evaluation results are shown in Table 1.

### Example 9

Except that the Pt—Pd-containing solution A2 was used in place of the Pt-containing solution A1 to have Pt—Pd alloy particles (9.1% by mass of Pd) as catalytic noble metal particles supported directly on a honeycomb substrate, the same operation as in Example 8 was used to produce an exhaust gas purification catalytic device of Example 9, and the produced catalytic device was evaluated. The evaluation results are shown in Table 1.

### Comparative Example 1

### (1) Production of Exhaust Gas Purification Catalytic Device

The same type of cordierite honeycomb substrate (capacity of about 1 L) as the one used in Example 1 was coated with a Pt/Al₂O₃-containing slurry in a range of 80% of the substrate length from a downstream end of an exhaust gas flow and baked at 500° C. for 1 h to form an NH₃ oxidation catalyst layer comprising Pt/Al₂O₃ on the honeycomb substrate.

Subsequently, a honeycomb substrate on which an NH₃ oxidative catalyst layer was formed was coated with the zeolite-containing slurry B1 over the entire length of the honeycomb substrate and baked at 500° C. for 1 h to form an SCR catalyst layer thereon, whereby an exhaust gas purification catalytic device of Comparative Example 1 was produced.

### (2) Evaluation of Exhaust Gas Purification Catalytic Device

The obtained exhaust gas purification catalytic device was evaluated in the same manner as in Example 1. The evaluation results are shown in Table 1.

### Comparative Example 2

An exhaust gas purification catalytic device produced in the same manner as in Comparative Example 1 was further baked at 630° C. for 50 h, whereby an exhaust gas purification catalytic device of Comparative Example 2 was produced.

The obtained exhaust gas purification catalytic device was evaluated in the same manner as in Example 1. The evaluation results are shown in Table 1.

### Comparative Example 3

An exhaust gas purification catalytic device produced in the same manner as in Example 1 was further baked at 630° C. for 50 h, whereby an exhaust gas purification catalytic device of Comparative Example 3 was produced.

The obtained exhaust gas purification catalytic device was evaluated in the same manner as in Example 1. The evaluation results are shown in Table 1.

TABLE 1

| | Catalytic noble metal particles supported | | | | | | | | | | |
|---|---|---|---|---|---|---|---|---|---|---|---|
| | directly on substrate | | | | | | | | | Evaluation results | |
| | Supported amount of | | | Carrier of | Average particle | | SCR catalyst layer | | | NH₃ | |
| | noble metal | | | noble | size of noble | Presence | Zeolite | | Silicone | oxidation | N₂O |
| | Pt | Pd | Pd ratio in | metal | metal particles | of OSC | | Coating amount | binder | rate | selectivity |
| | (g/L) | (g/L) | noble metal | particles | (nm) | layer | Type | (g/L) | (g/L) | (%) | (%) |
| Example 1 | 0.10 | 0.00 | 0.0 wt % | Substrate | 60 | No | Cu—CHA | 85 | 15 | 90 | 40 |
| Example 2 | 0.10 | 0.01 | 9.1 wt % | Substrate | 55 | No | Cu—CHA | 85 | 15 | 85 | 44 |
| Example 3 | 0.10 | 0.01 | 9.1 wt % | Substrate | 92 | No | Cu—CHA | 85 | 15 | 83 | 31 |
| Example 4 | 0.10 | 0.02 | 16.7 wt % | Substrate | 56 | No | Cu—CHA | 85 | 15 | 76 | 58 |
| Example 5 | 0.10 | 0.00 | 0.0 wt % | Substrate | 60 | No | Cu—BEA | 85 | 15 | 90 | 40 |
| Example 6 | 0.10 | 0.00 | 0.0 wt % | Substrate | 60 | No | Fe—MFI | 85 | 15 | 90 | 39 |
| Example 7 | 0.10 | 0.00 | 0.0 wt % | Substrate | 60 | No | Fe—BEA | 85 | 15 | 90 | 39 |
| Example 8 | 0.10 | 0.00 | 0.0 wt % | Substrate | 68 | Yes | Cu—CHA | 85 | 15 | 98 | 35 |
| Example 9 | 0.10 | 0.01 | 9.1 wt % | Substrate | 62 | Yes | Cu—CHA | 85 | 15 | 98 | 39 |
| Comparative | 0.10 | 0.00 | 0.0 wt % | Al₂O₃ | 2 | No | Cu—CHA | 85 | 15 | 10 | 86 |
| Example 1 | | | | | | | | | | | |
| Comparative | 0.10 | 0.00 | 0.0 wt % | Al₂O₃ | 18 | No | Cu—CHA | 85 | 15 | 99 | 60 |
| Example 2 | | | | | | | | | | | |
| Comparative | 0.10 | 0.00 | 0.0 wt % | Substrate | 132 | No | Cu—CHA | 85 | 15 | 15 | 24 |
| Example 3 | | | | | | | | | | | |

The following can be understood with reference to Table 1.

In the exhaust gas purification catalytic device of Comparative Example 3 in which the average particle size of the catalytic noble metal particles was large, the NH₃ oxidation rate was as low as 15%. On the other hand, in the exhaust gas purification catalytic devices of Comparative Examples 1 and 2 in which the average particle size of the catalytic noble metal particles was small, the N₂O selectivity was as high as 86% (Comparative Example 1) or 60% (Comparative Example 2).

The exhaust gas purification catalytic devices of Examples 1 to 9 of the present invention, wherein the average particle size of the catalytic noble metal particles was 30 nm or more and 120 nm or less, were shown to have NH₃ oxidation rate as high as 83% or greater and N₂O selectivity as low as 58% or less, and were excellent in both NH₃ oxidative purification ability and N₂O slip characteristic. Of these Examples, Examples 1 to 3 and 5 to 9, in which the amount of Pd contained in the catalytic noble metal particles was 0.15 g/L or less, were shown to have N₂O selectivity of 44% or less, which is a very low value.

In the exhaust gas purification catalytic device of the present invention, even when the zeolite contained in the SCR catalyst layer was changed to Cu-CHA type (Examples 1 to 4, 8, and 9), Cu-BEA type (Example 5), Fe-MFI type (Example 6), or Fe-MEA type (Example 7), both NH₃ oxidative purification ability and N₂O slip characteristic were verified to be excellent.

As seen in the evaluation results of the exhaust gas purification catalytic device of Examples 8 and 9, when an OSC layer was arranged between the substrate and the SCR catalyst layer, it was verified that NH₃ oxidative purification ability and N₂O slip characteristic were not impaired, and particularly, the NH₃ oxidative purification ability exhibited very high performance.

### REFERENCE SIGNS LIST

10 substrate
11 catalytic noble metal particles
20 SCR catalyst layer
30 OSC layer
101, 102 exhaust gas purification catalytic device

1. An exhaust gas purification catalytic device, comprising a substrate and an SCR catalyst layer on the substrate, wherein
the substrate comprises catalytic noble metal particles supported directly on the substrate,
the catalytic noble metal particles comprise Pt, and
the catalytic noble metal particles have an average particle size of 30 nm or more and 120 nm or less.

2. The exhaust gas purification catalytic device according to claim 1, wherein a noble metal other than Pt in the catalytic noble metal particles has a content ratio of 10% by mass or less with respect to a total mass of the catalytic noble metal particles.

3. The exhaust gas purification catalytic device according to claim 1, wherein the catalytic noble metal particles have an average particle size of more than 50 nm and 100 nm or less.

4. The exhaust gas purification catalytic device according to claim 1, wherein the SCR catalyst layer comprises a zeolite doped with Cu or Fe.

5. The exhaust gas purification catalytic device according to claim 4, wherein the SCR catalyst layer comprises at least one selected from Cu-CHA type zeolite, Cu-BEA type zeolite, Fe-MFI type zeolite, and Fe-BEA type zeolite.

6. The exhaust gas purification catalytic device according to claim 1, wherein the catalytic noble metal particles further comprise Pd.

7. The exhaust gas purification catalytic device according to claim 1, wherein the exhaust gas purification catalytic device is substantially free of any noble metal other than the catalytic noble metal particles supported directly on the substrate.

8. The exhaust gas purification catalytic device according to claim 1, further including an OSC layer comprising ceria.

9. The exhaust gas purification catalytic device according to claim 8, wherein the ceria is contained in the OSC layer in a ceria-zirconia composite oxide form.

10. The exhaust gas purification catalytic device according to claim 9, wherein the OSC layer is included between the substrate and the SCR catalyst layer

11. The exhaust gas purification catalytic device according to claim 4, wherein the catalytic noble metal particles further comprise Pd.

12. The exhaust gas purification catalytic device according to claim 4, wherein the exhaust gas purification catalytic device is substantially free of any noble metal other than the catalytic noble metal particles supported directly on the substrate.

13. The exhaust gas purification catalytic device according to claim 4, further including an OSC layer comprising ceria.

14. The exhaust gas purification catalytic device according to claim 11, wherein the exhaust gas purification catalytic device is substantially free of any noble metal other than the catalytic noble metal particles supported directly on the substrate.

15. The exhaust gas purification catalytic device according to claim 11, further including an OSC layer comprising ceria.

16. The exhaust gas purification catalytic device according to claim 14, further including an OSC layer comprising ceria.

17. An exhaust gas purification method which comprises purifying NOx in an exhaust gas emitted from a diesel engine using the exhaust gas purification catalytic device according to claim 1 and ammonia as a reductant.
